(19) United States
(12) Patent Application Publication
(10) Pub. No.: US 2024/0195169 A1
(43) Pub. Date: Jun. 13, 2024

(54) Transformer-Hybrid Variable Reactance

(71) Applicant: Richard V. Clark, Newport Richey, FL (US)

(72) Inventor: Richard V. Clark, Newport Richey, FL (US)

(21) Appl. No.: 17/803,814

(22) Filed: Dec. 8, 2022

(51) Int. Cl. H02H 7/04; H01F 27/24; H01F 27/28; H05K 7/20

(52) U.S. Cl. CPC H02H 7/04; H01F 27/24; H01F 27/28; H05K 7/209; H05K 7/20936

(57) ABSTRACT

A device that improves electrical power and current flow between the source and load using a unique combination of solid state semiconductor and variable impedance technologies. Pure solid state semiconductor power circuits produce non-linear and peak current flow that can cause protection devices, such as breakers and fuses to nuisance trip when driving high inrush variable resistive and inductive loads. Variable reactance transformers, on the other hand, address these irregularities but at the expense of higher energy costs, physical size and weight. The invention solves the above mentioned deficiencies by the design of new improved electrical and mechanical devices. On the electrical side is a superior variable impedance regulator circuit, in combination with a DC saturable transformer core and coil, that when activated keeps current spikes and abnormal flows within the circuit from occurring. This prevents circuit protection devices from false failures which increase equipment reliability. Production downtime and or part failures can mean the success or failure of a business! On the mechanical side is the integration of two new types of semiconductor heat sinks, single and double sided, and one new transformer coil type heat exchanger. The devices when built into the new improved hybrid variable reactance transformer (or HVRT for short) carries heat away in an extremely compact package. The result is a smaller and lighter unit that saves in both plant physical floor space and initial shipping costs.

### BACKGROUND OF THE INVENTION

This invention relates to an electrical transformer that incorporates a unique combination of transformer, semiconductor and saturable DC coil technology to regulate and control precise power to an electrical load without failure. Controllable transformers are used in a variety of ways to vary voltage and current from a source to an electrical load. In prior arts, U.S. Pat. Nos. 3,343,074 and 3,505,588 utilize a variable reactance transformer (VRT) to achieve this. A major drawback with this technology is the electrical efficiency, size and weight of the device. Typical VRT's have an overall electrical efficiency of 70 to 80 percent as compared to the new invention which is 85 to 90 percent. Another major improvement is size and weight. The device mentioned is 33 to 50 percent lighter and requires 25-30 percent less space. All measurements are in reference to the total amount of electrical power (kilowatts) being converted. All features result in lower utility, installation and shipping costs. This is a direct savings to the end user. Other prior art patents such as U.S. Pat. Nos. 10,048,708 B2, 10,353,412 and 10,984,985 do not address these issues.

### SUMMARY OF INVENTION

The present invention is directed to a self contained transformer that utilizes semi conductors, electronic regulators and transformer windings to produce greater electrical efficiencies and reliability. The device comprises, in combination of a thermally efficient semiconductor heat sink, voltage, current and impedance regulators, external references, a main magnetic transformer core with primary, secondary and saturable DC core windings.

The device works by first receiving an input command or reference from an external source. It then compares and sums the reference sources to the voltage, current and impedance feedback signals produced by devices in the main power circuit. An error signal within the circuitry is produced which then advances or retards a main power semiconductor. The semiconductor which now starts to advance conduct, supplies variable/proportional voltage and current to the load thru the main transformer and DC core windings. The electronic circuit is satisfied when the difference between the error and feedback signals are equal. Hence, power regulation is achieved. During this period the current limit and saturable DC core windings are working in tandem to ensure smooth limited current flow and thus reliable, regulated and efficient power is now transferred from source to load. The heat produced from the semiconductor is absorbed thru a strategically placed and specially designed heat sink that is an integral part of the main transformer. It yields a smaller lighter package than conventional VRT's of an equal power level. The cooling medium, which flows thru the heat sink also flows and carries heat away from the magnetic core and windings of the transformer. The cooling agent can be in a liquid or vapor form.

### DESCRIPTION OF THE DRAWINGS

FIG. 1 is a schematic view of the hybrid variable reactance transformer with the semiconductor located in the secondary according to the embodiment of the invention.

FIG. 2 is a schematic view of the hybrid variable reactance transformer with the semiconductor located in the primary according to the embodiment of the invention.

FIG. 3 is a partial diagrammatic illustration showing the HVRT, single sided secondary heat sink and coolant flow thereof.

FIG. 4 is a detailed view of the single sided heat sink and semiconductor attached.

FIG. 5 is a partial diagrammatic illustration showing the HVRT, double sided primary heat sink and coolant flow thereof.

FIG. 6 is a detailed view of the double sided heat sink and semiconductor attached.

FIG. 7 is a detailed illustration of high temperature tubing wrapped around the HVRT for the purpose of an additional cooling means.

FIG. 8 is an equivalent electrical schematic view of the HVRT transformer with secondary semiconductors and wave forms at normal operating conditions.

FIG. 9 is the same as FIG. 8 above but at 50 percent current limited, impedance applied conditions.

FIG. 10 is a partial diagrammatic illustration of three HVRT transformers constructed in accordance with the invention and connected in a three-phase delta system.

### DESCRIPTION OF THE PREFERRED EMBODIMENTS

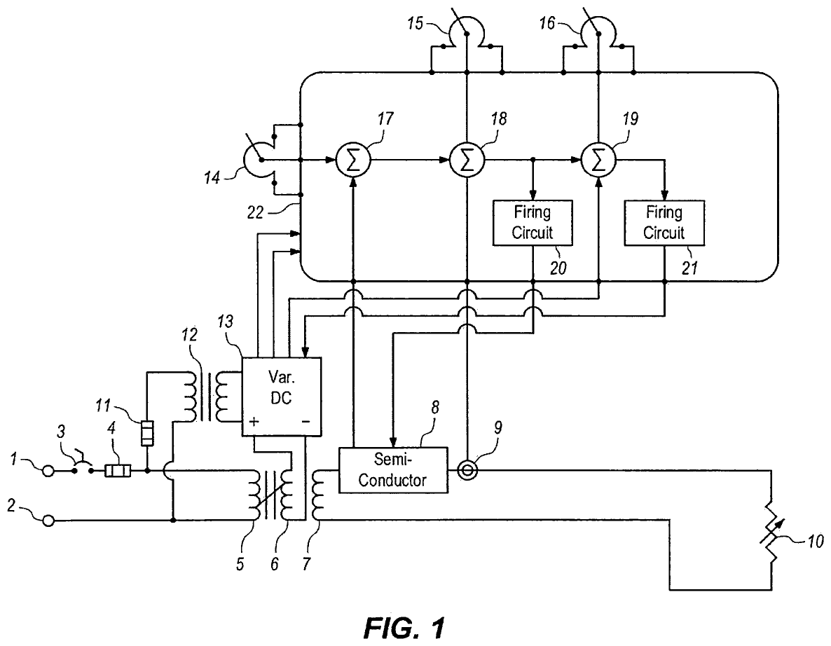

Turning now to a more detailed consideration of the present invention. In FIG. 1, a AC power source is applied to terminals land 2. It then powers the primaries of transformers 5 and 12 thru circuit protection 3, 4 and 11. Transformer 12, which is now energized, provides secondary power to a variable DC rectifier which will provide current to reactor coil 6. It also provides AC power to board 22 on which the hybrid variable reactance transformer (HVRT) regulators reside. Upon receiving a voltage command reference from 14, it is compared and summed at 17 with feedback from 8. The error produced gets compared and summed at 18 with current reference 15 and CT feedback 9. The error produced then get compared and summed at 19 with the impedance reference 16 and feedback from 13. The error from output 18 drives firing circuit 20 which provides a phase angle conduction signal to semi conductor 8. Said semiconductor 8 is a pair of inverse parallel SCR's located in the secondary of 7. The main secondary output coil 7, which is now energized, start to transfer regulated voltage and current to load 10. If the current levels approach the reference 15 and error signal 18 exceeds the impedance reference 16, then the output of 19 starts to drive firing circuit 21. The variable DC power supply, which gets it inversely proportional conduction signal from the output of 21, starts retarding or advancing DC current flowing in reactor coil 6. The DC current that flows increases or decreases the primary 5 to secondary7 impedance. This impedance change acts as an additional current buffer which will keep primary current flowing in 5 smooth and limited to the extent that circuit breaker 3 and fuse 4 will not trip or blow. This scenario is also known as nuisance tripping. Nuisance tripping can cause power interruption to load 10 which may result in major production, part and electrical energy losses.

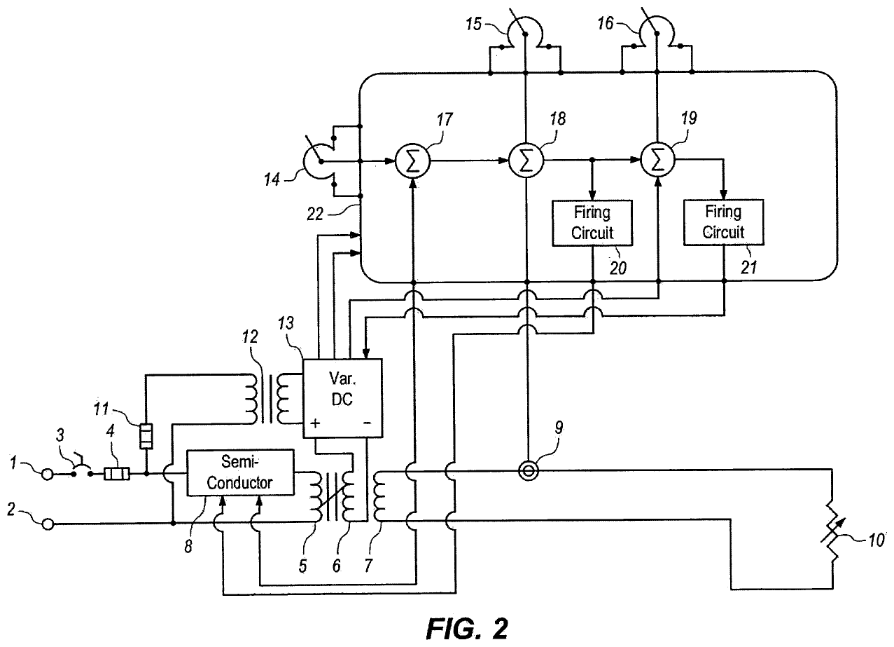

In FIG. 2 a AC power source is applied to terminals 1 and 2. It then powers the primary transformer 12 thru circuit protection 3, 4 and 11. Transformer 12, which is now energized, provides secondary power to a variable DC rectifier which will provide current to reactor coil 6. It also provides AC power to board 22 on which the hybrid variable reactance transformer (HVRT) regulators reside. Upon receiving a voltage command reference from 14, it is compared and summed at 17 with feedback from 8. The error produced gets compared and summed at 18 with current reference 15 and feedback 9. The error produced then get compared and summed at 19 with the impedance reference 16 and feedback from 13. The error from output 18 drives firing circuit 20 which provides a phase angle conduction signal to semi conductor 8. Said semiconductor 8 is a pair of inverse parallel SCR's located in the primary of 5. The main secondary output coil 7, which is now energized, start to transfer regulated voltage and current to load 10. If the current levels approach the reference 15 and error signal 18 exceeds the impedance reference 16, then the output of 19 starts to drive firing circuit 21. The variable DC power supply, which gets its inversely proportional conduction signal from the output of 21, starts retarding or advancing DC current flowing in reactor coil 6. The DC current that flows increases or decreases the primary 5 to secondary7 impedance. This impedance change acts as an additional current buffer which will keep primary current flowing in 5 smooth and limited to the extent that circuit breaker 3 and fuse 4 will not trip or blow. This scenario is also known as nuisance tripping. Nuisance tripping can cause power interruption to load 10 which may result in major production, part and electrical energy losses.

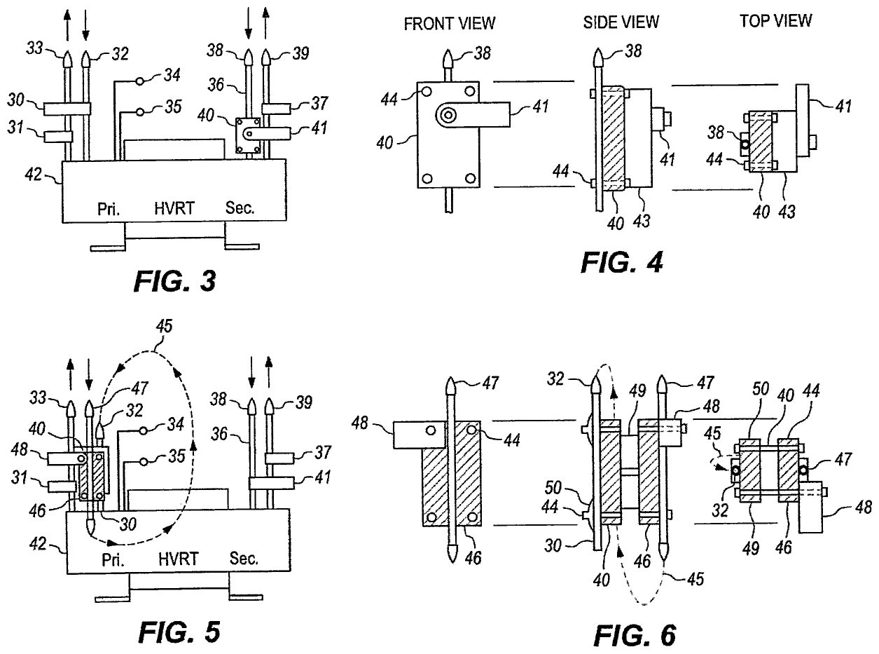

In FIG. 3, a partial diagrammatic illustration shows the HVRT 4.2 windings, single sided heat sink and cooling components thereof. Also shown is the semiconductor located in the secondary side of HVRT 42. The primary coil winding start lead is 30 and finish is 31. The reactor DC coil winding start lead is 34 and finish is 35. The secondary coil winding start lead is 36, finish is 37 and semiconductor output lead is at 41. The coolant enters at 38 and starts flowing thru the semiconductor single sided heat sink 40, then into the secondary coil and exits 39. The coolant also flows thru the primary coil starting at 32 and then exits 33. The heat produced from the semiconductor heat sink 40 and HVRT 42 when under electrical load is absorbed by the coolant and discharged accordingly. It is important to note that winding conductors 30, 31, 36 and 37 are hollow inside for coolant to run thru.

In FIG. 4, a detailed view of the single sided semiconductor heat sink is shown. The heat sink 40 is extremely small, compact, and efficient and is an integral part of HVRT 42. The semiconductor 43 is fastened on by four bolts 44, each being torqued to the proper specification. Coolant line and conductor 38 is bonded to the conductive plate 40 so that maximum thermal energy can be transferred into the flow of the coolant, thus keeping the semiconductor cool while under full electrical load. Conductor lead 41 provides a connection point to complete the circuit.

In FIG. 5, a partial diagrammatic illustration shows the HVRT 42 windings, double sided heat sink and cooling components thereof. Also shown is the semiconductor located in the primary side of HVRT 42. The input power lead 48 is connected to one side of heat sink 46. The semiconductor 49 is located in between the opposing heat sink 40. The primary coil winding start lead is 30 and finish is 31. The reactor DC coil winding start lead is 34 and finish is 37. The secondary coil winding start lead is 36 and finish is 37. The heat produced from the semiconductor heat sinks 46, 40 and HVRT 42 when under electrical load is absorbed by the coolant and discharged accordingly. It is important to note that the winding conductors 30, 31, 36 and 37 are hollow inside for coolant to run thru.

In FIG. 6, a detailed view of the double sided semiconductor heat sink is shown. The two heat sinks 40 and 46 with semiconductor 49 in between is extremely small, compact, efficient and is an integral part of HVRT 42. Semiconductor 49 is held between the two plates by insulated fasteners 44. The four bolts 44 with insulating washed 50 are all torque to the proper specification. A electrically insulated hose 45 directs coolant flow out of 47 and into 32. Coolant lines 47 and 32 are bonded to their respected conductive heat sink plates 46 and 40 so that maximum thermal energy can be transferred into the flow of the coolant, thus keeping the semiconductor cool while under full electrical load. Conductor lead 48 provides a connection point to complete the electrical circuit.

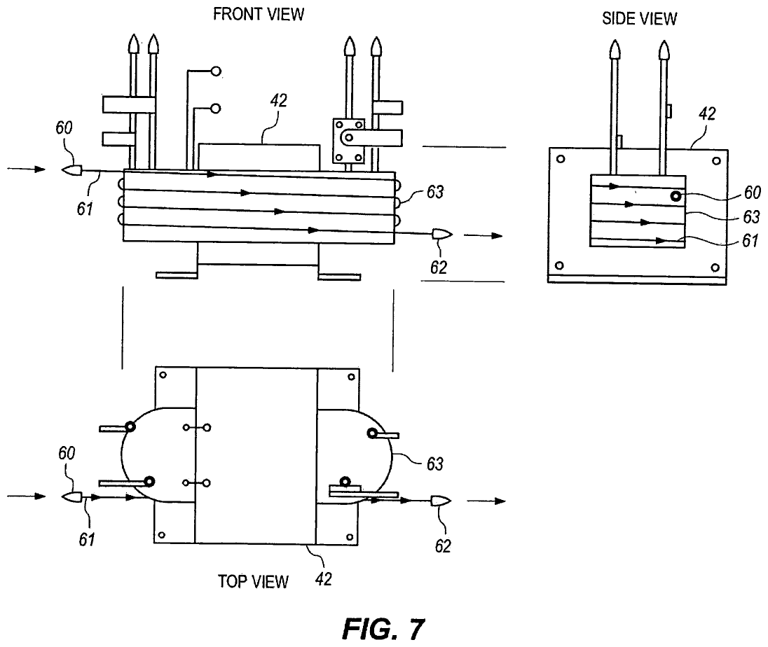

In FIG. 7, an illustration is shown comprising of a high temperature tube 61 for coolant to flow thru. It provides additional HVRT 42 winding and core cooling if required. The arrangement is such that coolant enters a fitting at 60. As it travels thru tube 61, it extracts thermal energy released during transformer electrical loading. The number of turns is calculated and determined by the power level (in kilowatts), flux core density, winding impedances, flow and type of coolant, maximum ambient and HVRT 42 temperatures and type of bonding agent 63. The heat that is absorbed by the coolant gets discharged at fitting 62.

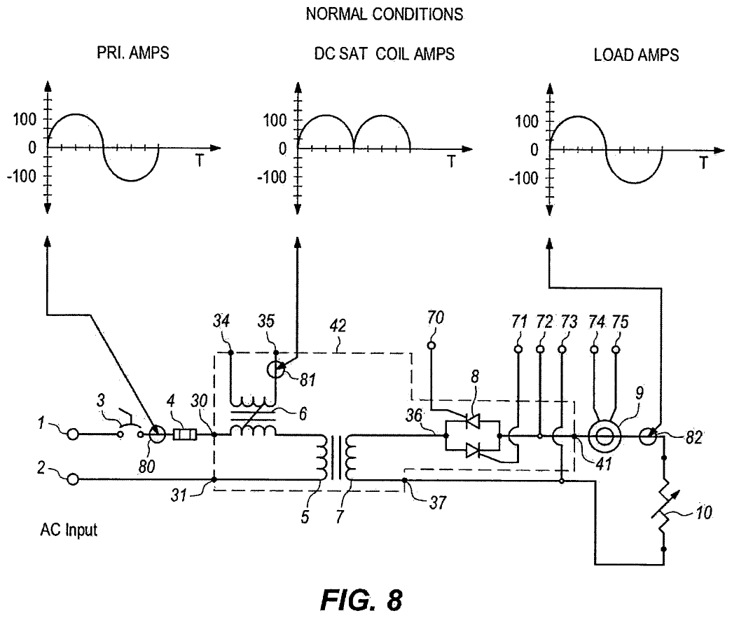

FIG. 8 shows an equivalent electrical schematic view of the HVRT transformer 42 with secondary semiconductors and waveforms under normal loading conditions with power applied to a AC sinusoidal source 1 and 2. More specifically, the semiconductors located in the secondary side of HVRT 42 are a set of 8 inverse parallel connected SCR's. When firing pulses are applied to gates 70 and 71, a phase angle controllable current sine wave output is produced. Depending on the command signal input, the voltage feedback signal 72 to 73, current limit setting and current feedback signal 74 and 75 from the current transformer 9, will determine the exact phase angle for voltage, current and power to be delivered to load 10. In this depiction, the command input from potentiometer 14 is 100 percent. Current limit potentiometer 15 is at 100 percent and impedance potentiometer 16 is at zero percent, then the current waveforms at points 80 and 82 will be pure sinusoidal at full load output. The current ratio is determined by the turns ratio of coils 5 and 7. For this illustration it is set at one to one (1:1). The saturable DC coil current, which produces no impedance change in 6 is full on or at 100 percent. The maximum impedance range of change is set by the turn ratio of DC coil 34 and 35. In this case, zero DC current will yield an impedance change through reactor coil 6 of 10 percent and 100 percent is zero. Said DC reactor coil current is inversely proportional to the percent impedance through element 6 in the primary circuit.

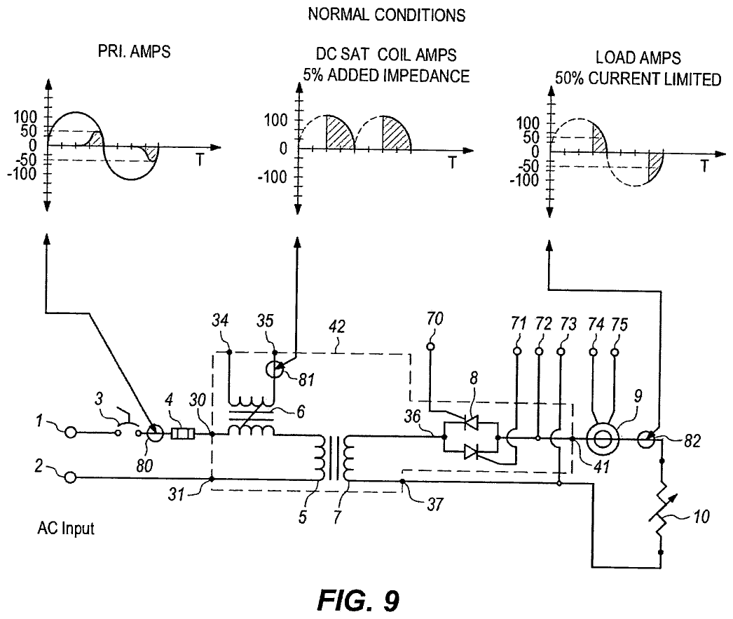

FIG. 9 is in a normal operating condition but in a current limited impedance applied capacity. Said command input potentiometer 14 is 100 percent and current limit potentiometer 15 and impedance potentiometer 16 are both set at 50 percent. As shown, the current peak or spike flowing in 82 is slightly above the 50 percent threshold due to the non-linear nature of phase angle conduction of the semiconductor SCR's and feedback from the current transformer (CT) 9. However, when reflected into the primary, the saturable reactor coil 6, which has now increased its impedance by 5 percent, smooths the current spike out, thus keeping current flowing to the limited 50 percent required. This prevents the nuisance tripping of components circuit breaker 3 and fuse 4.

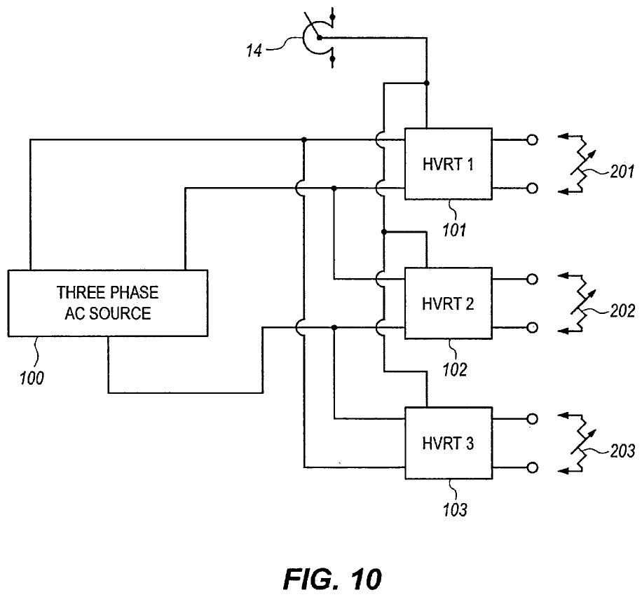

FIG. 10 is a partial diagrammatic illustration of three HVRT transformers arranged in a delta three phase AC input power configuration. Command reference from potentiometer 14 is connected to HVRT 1 or 101, HVRT 2 or 102 and HVRT 3 or 103. The outputs of these three HVRT transformers can power independent loads 201, 202 and 203 directly or the outputs of 101, 102 and 103 can also be configured to drive loads 201, 202 and 203 in a three phase wye or delta.

The invention claim:

1. A device that controls electrical power from source to load, in a reliable and efficient manner comprising, in combination:
means for a main power semiconductor;
means for a main electrical transformer;
means for cooling;
means for detecting when said command reference is above or below the actual set point;
means for comparing when said reference current is above or below the actual set point;
means for producing an output signal for said current;
means for driving said semiconductor;
means for comparing when said reference impedance is above or below the actual set point;
means for producing an output signal for said impedance;
means for driving said impedance coil;

2. A device as defined by claim 1, further including a self contained transformer that contains all the elements of the device except said electrical load.

3. A device as defined by claim 1, further including a main power semiconductor that has proportional control.

4. A device as defined by claim 3, wherein said semiconductor is a set of inverse parallel connected silicon controlled rectifiers.

5. A device as defined by claim 1, further including a main power transformer with windings and a magnetic core.

6. A device as defined by claim 5, wherein said main power transformer has a primary, secondary and variable impedance winding.

7. A device as defined by claim 5, wherein said conductive windings are hollow inside to carry coolant.

8. A device as defined by claim 1, further including a semiconductor heat sink.

9. A device as defined by claim 8, wherein a single plate is bonded to a hollow conductor for the purpose of extracting thermal energy.

10. A device as defined by claim 9, wherein a semiconductor is mounted to the plate.

11. A device as defined by claim 8, wherein two single plates are bonded to opposing hollow conductors for the purpose of extracting thermal energy.

12. A device as defined by claim 11, wherein a semiconductor is placed in between the two opposing plates and fastened together.

13. A device as defined by claim 1, further including a coolant tube winding for electrical power heat extraction.

14. A device as defined by claim 13, wherein a tube is wrapped and bonded to an electrical transformer.

15. A device as defined by claim 7, wherein said coolant can be a liquid or a gas.

16. A device as defined by claim 15, wherein said coolant can be freon.

17. A Hybrid variable reactance transformer that comprises, in combination:
means for a main power driver and semiconductor;
means for a said transformer with primary, secondary and impedance windings;
means for cooling the semiconductor heat sink and transformer;
means for voltage, current and impedance regulators;

18. A device as defined by claim 17, further including a self contained hybrid variable reactance transformer that incorporates a set of inverse parallel silicon controlled rectifiers, a liquid or gas cooled single or double sided heat sink, transformer primary, secondary and variable impedance windings with magnetic core, transformer tube cooler, and regulators with drivers. All elements are contained within except said electrical load.

19. A device as defined by claim 17, that can limit current and change impedance to keep electrical current flowing smoothly so circuit protection devices do not false trip.

20. A device as defined by claim 17, that due to improvements in cooling, in combination with the use of a semiconductor/s, yields a smaller, lighter more energy efficient and reliable transformer.

21. A device as defined by claim 18, that can be used to drive single or three phase delta-wye loads.
